(19) United States
(12) Patent Application Publication
(10) Pub. No.: US 2009/0256689 A1
(43) Pub. Date: Oct. 15, 2009

(54) IMAGE DISPLAY APPARATUS AND IMAGE DISPLAY METHOD

(75) Inventors: Hideo Nakaya, Kanagawa (JP); Tetsujiro Kondo, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/396,054

(22) Filed: Mar. 2, 2009

(30) Foreign Application Priority Data
Apr. 15, 2008 (JP) 2008-106133

(51) Int. Cl. H04B 3/36; G09G 5/00

(52) U.S. Cl. 340/407.1; 345/581

(57) ABSTRACT

An image display apparatus is disclosed. The image display apparatus includes a display section, vibrators, and a driving section. The display section displays an image. The vibrators each have a smaller size than that of each of pixels that compose the image and disposed on a display surface of the display section corresponding to the pixels. The driving section drives the vibrators.

### BACKGROUND OF THE INVENTION

1. Field of the Invention

The present invention relates to an image displaying apparatus and an image displaying method, in particular to those that provide vibrations along with an image.

2. Description of the Related Art

An image display apparatus converts an input video signal into light to represent luminance changes. Thus, an object captured by in image capturing apparatus such as a camera is displayed on a screen. However, from a viewpoint of real representation of texture of the object, such a technique does not satisfy the user.

In recent years, an apparatus called a “tactile display” that represents unevenness of an object with expansion/shrink of moving devices has been studied. Unevenness and shape of an object can be reproduced by this display.

For example, Japanese Unexamined Patent Application Publication No. 2006-47578 discloses a tactile display apparatus that allows the user to sense a solid shape represented by sensing protruded states of tactile pins that are two-dimensionally arranged on a plane operation panel.

### SUMMARY OF THE INVENTION

In the forgoing tactile display apparatus, since the size of the moving devices is as large as for example 1 to 2 mm, the tactual resolution inevitably decreases. In addition, it is difficult to say that the response speeds of the moving devices are as fast as the motion of an image. In addition, since the moving devices were not capable of representing colors of an image and luminance changes, there was a problem that even if the shape and texture of an object were able to be represented to some extent, details of an image were difficult to be represented.

In view of the foregoing, it would be desirable to tactually represent an object with both its texture and its image.

According to an embodiment of the present invention, there is provided an image display apparatus including a display section, vibrators, and a driving section. The display section displays an image. The vibrators each have a smaller size than that of each of pixels that compose the image and disposed on a display surface of the display section corresponding to the pixels. The driving section drives the vibrators.

Thus, an image is displayed with pixels of the display section and the vibrators disposed corresponding to the individual pixels that compose the image are operated.

According to an embodiment of the present invention, since an image is displayed with pixels of the display section and the vibrators disposed corresponding to the individual pixels that compose the image are operated, the user can recognize an object with his or her visual sense and tactual sense.

### BRIEF DESCRIPTION OF THE DRAWINGS

The invention will become more fully understood from the following detailed description, taken in conjunction with the accompanying drawings, wherein similar reference numerals denote corresponding elements, in which:

FIG. 1 is a schematic diagram showing an example of a structure of a system according to an embodiment of the present invention;

FIG. 2 is a side view showing an example of a structure of a screen according to an embodiment of the present invention;

FIG. 3 is an explanatory schematic diagram showing an example of driving of a vibration device according to an embodiment of the present invention;

FIG. 4 is a block diagram showing an example of an internal structure of a system according to an embodiment of the present invention;

FIG. 5 is an explanatory schematic diagram showing an example of calculations of individual parameters with which a vibration period of the vibrator is decided according to an embodiment of the present invention;

FIG. 6 is an explanatory schematic diagram showing an example of a structure of a vibration period deciding LUT according to an embodiment of the present invention;

FIG. 7A and FIG. 7B are explanatory schematic diagrams showing an example of the relationship of images and normalized vibration periods according to an embodiment of the present invention, FIG. 7A shows images, FIG. 7B shows normalized vibration periods that have been set corresponding to the images;

FIG. 8 is a block diagram showing an example of an internal structure of a vertical driving section and a horizontal driving section of an image display panel according to an embodiment of the present invention;

FIG. 9 is a block diagram showing an example of an internal structure of a vertical driving section and a horizontal driving section of a vibration device panel according to an embodiment of the present invention;

FIG. 10A to FIG. 10H are timing charts showing an example of an operation of the vertical driving section of the vibration device panel according to an embodiment of the present invention;

FIG. 11A to FIG. 11K are timing charts showing an example of an operation of the horizontal driving section of the vibration device panel according to an embodiment of the present invention;

FIG. 12 is a flowchart showing an example of a process of an image display apparatus according to an embodiment of the present invention; and

FIG. 13 is an explanatory schematic diagram showing an example of the relationship of pixels and vibration devices according to another embodiment of the present invention.

### DETAILED DESCRIPTION OF THE PREFERRED EMBODIMENTS

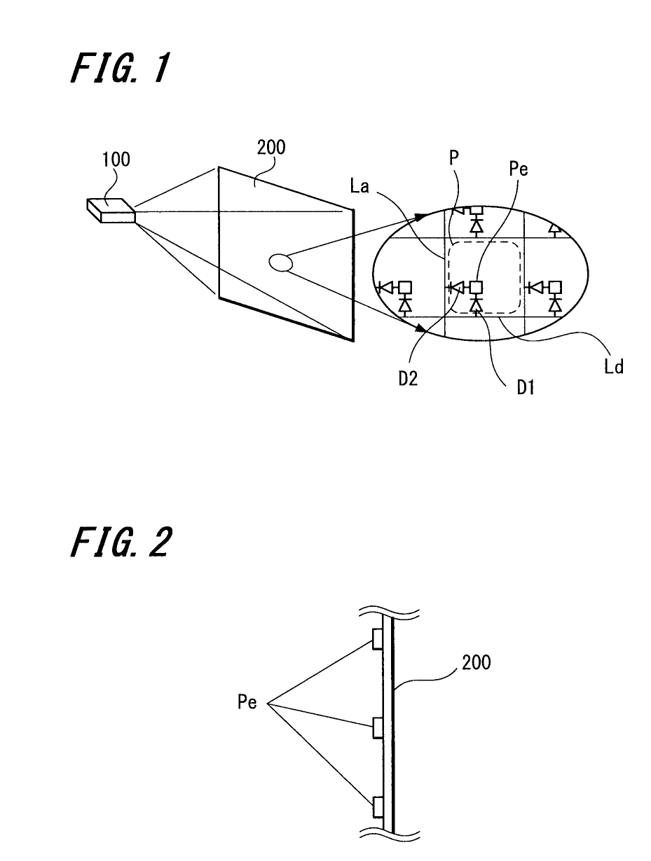

Next, with reference to the accompanying drawings, an embodiment of the present invention will be described. This embodiment is an image display apparatus that displays projection light of a projector to the screen. FIG. 1 is a schematic diagram showing an example of a structure of a system of the image display apparatus according to this embodiment.

The system shown in FIG. 1 is a rear-projection type projector. The projector 100 and a screen 200 (serving as a display section) on which projection light of the projector 100 is projected are housed in a housing (not shown). An image is projected on the rear surface of the screen 200 and the user watches the image in front of the screen 200.

As shown in a right-side enlarged view of FIG. 1, embedded in the screen 200 are vibration devices Pe (serving as a vibrator), diodes D1, and diodes D2. The vibration devices Pe are composed of a pressure-to-electricity converting device that vibrates in an ultrasonic band with a voltage applied. In this embodiment, as the pressure-to-electricity converting devices, Piezo-electric devices are used. The vibration devices Pe are disposed corresponding to pixels P that compose an image emitted from the projector 100 in the relationship of one to one.

In this example, the vibration devices Pe are sufficiently smaller than the corresponding pixels P such that the vibration devices Pe do not interfere with an image displayed on the screen 200. The vibration devices Pe may be disposed on any of the front surface and the rear surface of the screen 200. Since the pixels P on the screen 200 depend on an image projection process performed on the projector 100 side. Thus, devices that compose pixels are not disposed on the screen 200.

Since the vibration devices Pe are composed of pressure-to-electricity converting devices, voltages are applied to the vibration devices Pe, horizontal data wires Ld, vertical address wires La, diodes D1, and diodes D2 are mounted on the front surface (or rear surface) of the screen 200. These devices will be described later in detail.

FIG. 2 is a side view of the screen 200 shown in FIG. 1. As shown in FIG. 2, the vibration devices Pe are disposed at intervals of the pixels P on the front surface of the screen 200. The vibration devices Pe are disposed corresponding to the number of pixels of an image that is displayed. Instead, the vibration devices Pe corresponding to pixels near the center of the image may be disposed, while the vibration devices Pe corresponding to pixels P at the periphery of the image may be omitted. In FIG. 2, for easy understanding, the vibration devices Pe are illustrated in an increased size. In reality, as described above, the vibration devices Pe are structured in a smaller size than that of each of the pixels P.

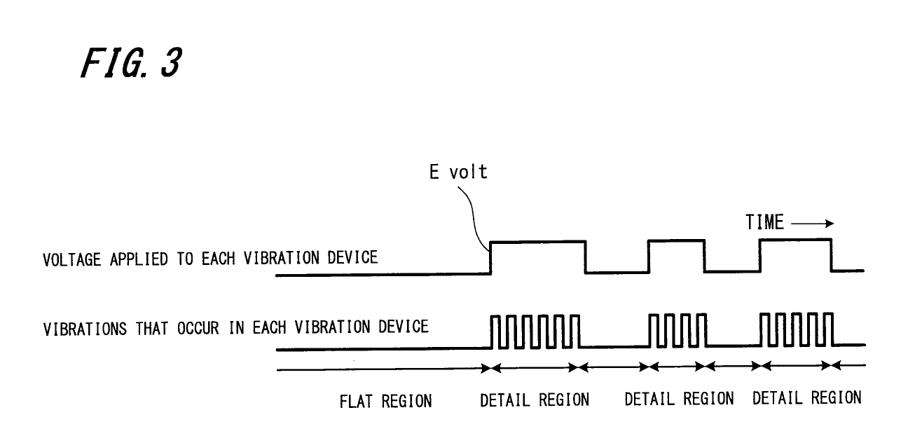

In this embodiment, the number of operating vibration devices Pe (or their vibration periods) disposed corresponding to pixels P can be changed based on a feature amount of an image projected on the screen 200. Specifically, the vibration devices Pe are controlled such that they are operated in an uneven area in a pattern of a displayed image and they are not operated in a flat area. FIG. 3 is an explanatory schematic diagram showing this control. In FIG. 3, an upper waveform shows changes of a voltage applied to each vibration device Pe on a time base and a lower waveform shows vibration states of each vibration device Pe.

In FIG. 3, in an area determined to be an uneven area (detail region) in the pattern of the image, a voltage of E volt is applied to the vibration devices Pe, whereas in an area determined to be a flat area (flat region) in the pattern of the image, no voltage is applied to the vibration devices Pe. This control causes the vibration devices Pe to operate in an uneven region of an image and not to operate in a flat region thereof.

The number of vibrations of each of the vibration devices Pe depends on the physical size of the piezoelectric devices. Thus, in this embodiment, since the sizes of the piezoelectric devices are identical, to change the numbers of vibrations of each of the Piezo-electric devices corresponding to its mounted position, the period for which the voltage is applied to each of the Piezo-electric devices Pe is adjusted. In other words, in a finely uneven region of an image, the period for which the voltage of E volt is applied is increased, whereas in a roughly uneven region, the period for which the voltage of E volt is applied is decreased. As a result, the number of vibrations of each of the vibration devices Pe can be changed corresponding to the texture of the image. Details of controlling of the number of vibrations will be described later.

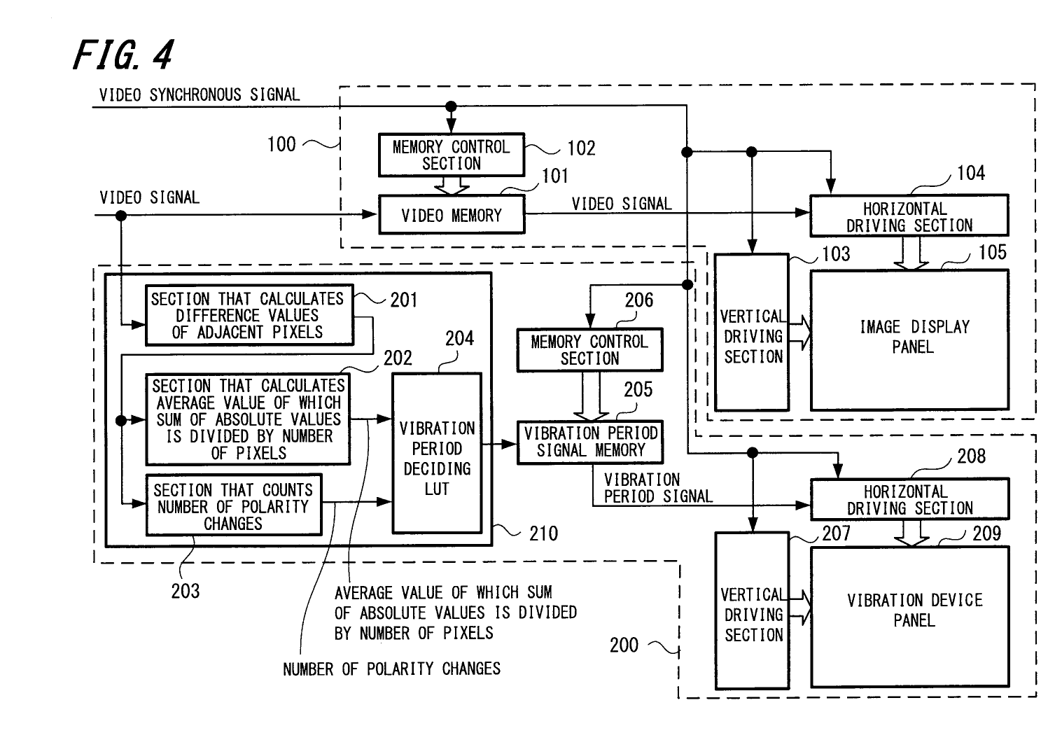

Next, with reference to FIG. 4, an example of an internal structure of the system according to this embodiment will be described.

First, the structure of the projector 100 will be described. The projector 100 includes a video memory 101 that stores a video signal for one frame and a memory control section 102 that controls reading and writing of the video signal from and to the video memory 101 in synchronization with a video synchronous signal.

In addition, the projector 100 includes a vertical driving section 103 that selects a vertical address wire based on the video synchronous signal. Moreover, the projector 100 includes a horizontal driving section 104 that successively converts a video signal for one line that is output from the video memory 101 into an analog video signal under the control of the memory control section 102 and outputs the analog video signal to the horizontal data wires. The vertical address wires, horizontal data wires, and pixels P controlled therethrough are disposed on an image display panel 105 in a matrix shape. Detail structures of the vertical driving section 103 and the horizontal driving section 104 will be described later.

The screen 200 includes a control section 210, a vibration period signal memory 205, a memory control section 206, a vertical driving section 207, a horizontal driving section 208, and a vibration device panel 209 (the vertical drive section 207 and the horizontal drive section 208 serve as a driving section). The control section 210 calculates parameters with which the vibration periods of the vibration devices Pe are decided, generates a vibration period signal that represents information about the lengths of vibration periods based on the calculated parameters, and outputs the generated vibration period signal to the vibration period signal memory 205. Details of the control section 210 will be described later.

The vibration period signal memory 205 stores the vibration period signal generated in the control section 210. The memory control section 206 controls reading and writing of the vibration period signal from and to the vibration period signal memory 205 in synchronization with the video synchronous signal. The vertical driving section 207 selects a vertical address wire La (see FIG. 1) to be driven corresponding to the video synchronous signal. The horizontal driving section 208 converts the vibration period signal for one line that is output from the vibration period signal memory 205 into a pulse width modulation (PWM) signal under the control of the memory control section 206 and outputs the PWM signal to the individual horizontal wires Ld (see FIG. 1). The vertical address wires La, the horizontal data wires Ld, and the vibration devices Pe controlled therethrough are arranged in a matrix shape on the vibration device panel 209. In this embodiment, the positions of the vibration devices Pe arranged on the vibration device panel 209 correspond to those of the individual pixels P on the image display panel 105 in the relationship of one to one.

Next, details of the structure of the control section 210 will be described. The control section 210 includes a section that calculates the differences of adjacent pixels (referred to as the difference calculation section) 201, a section that calculates the average value of which the sum of the absolute values is divided by the number of pixels (this section is referred to as the average value calculation section) 202, a section that counts the number of polarity changes (referred to as the counting section) 203, and a vibration period determination look up table (LUT) 204 (serving as a table). The difference calculation section 201 calculates the difference values of adjacent pixels in a predetermined area around a pixel under consideration, for example N pixels (where N is a natural number) in the horizontal direction of an image. In this embodiment, the difference values of pixel values in the horizontal direction of an image are obtained. Instead, the difference values of pixel values in the vertical direction of an image may be obtained. Instead, the difference values of pixel values both in the horizontal direction and the vertical direction may be obtained.

The average value calculation section 202 adds the absolute values of the difference values of adjacent pixels in the predetermined region, which have been calculated by the difference calculation section 201, obtains the sum of the absolute values, divides the sum by the number of pixels P, and obtains the average value of which the sum of the absolute values of the difference values of adjacent pixels is divided by the number of pixels. The counting section 203 detects the number of polarity changes of pixel values in the horizontal direction of the image and counts the number of polarity changes in the predetermined region.

The vibration period deciding LUT 204 is a table that correlates the average values of which the sum of the absolute values of difference values of adjacent pixels is divided by the number of pixels, the numbers of polarity changes, and the vibration periods for which a vibration device Pe is vibrated. With the average value of which the sum of the absolute values of the difference values of the adjacent pixels is divided by the number of pixels and the number of polarity changes, the vibration period for which a vibration device Pe is vibrated can be uniquely obtained from the vibration period deciding LUT 204.

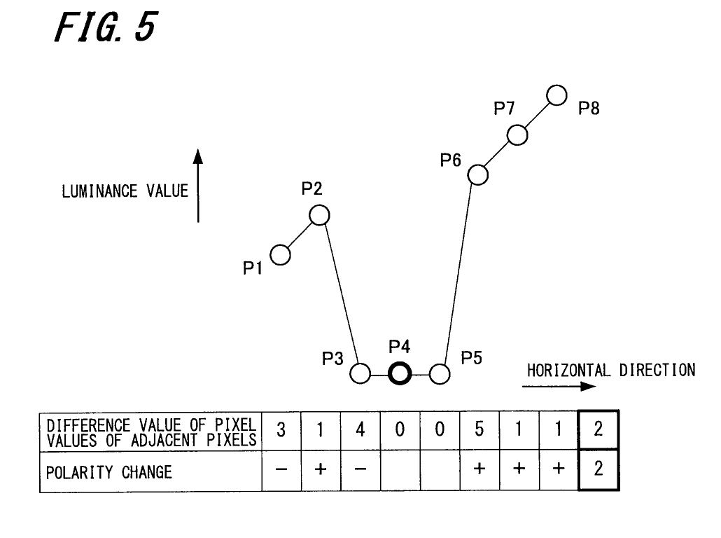

FIG. 5 shows an example of calculations of various types of parameters used in the difference calculation section 201, the average value calculation section 202, and the counting section 203. A graph shown in FIG. 5 (upper part) represents changes of pixel values in the horizontal direction of an image, the horizontal axis represents the horizontal direction and the vertical axis represents luminance values (pixel values). Circles on the graph represent pixels. In the example shown in FIG. 5, various types of parameters are calculated in a region composed of eight pixels, pixel P1 to pixel P8, around a pixel under consideration P4.

An upper row of a table shown in FIG. 5 (lower part) represents absolute values of difference values of each pixel P and each of its adjacent pixels. A lower row of the table represents changes of polarities of adjacent pixels with “+ (plus)” and “− (minus)”. As represented in the upper row, the difference calculation section 201 calculates the absolute values of difference values of each pixel P and its adjacent pixels in a predetermined region, divides the sum of the difference values by the number of pixels P, and calculates the average value of which the sum of the absolute values of the difference values of adjacent pixels is divided by the number of pixels. In the example of the table shown in FIG. 5, since the absolute values of the difference values of the adjacent pixels P in the horizontal direction are 3, 1, 4, 0, 0, 5, 1, 1, the average value of which the sum of the absolute values of the difference values of the adjacent pixels is divided by the number of pixels becomes (3+1+4+0+0+5+1+1)/8=1.875≈2.

In FIG. 5, as polarity changes of pixel values in the horizontal direction of the image, since the pixel values increase from pixel P1 to pixel P2, the polarity of pixel P2 is “+” (plus). Since the pixel values decrease from pixels P2 to P3, the polarity of pixel P3 is “−” (minus). Since the pixel value of pixel P3 is the same as the pixel value of pixel P4, the polarity of pixel P4 does not change. Since the pixel values simply increase from pixel P5 to pixel P8, the polarities of pixel P5 to pixel P8 are all “+” (plus). Thus, in this region, the polarities do not change. As a result, in this region, the number of polarity changes is two. The counting section 203 performs such a process to count the number of polarity changes.

In other words, when the number of polarity changes in a predetermined region is large, it can be determined that unevenness of an image in the region be fine. In contrast, when the number of polarity changes is small, it can be determined that unevenness of the image in the region be rough or changes of the image be simple.

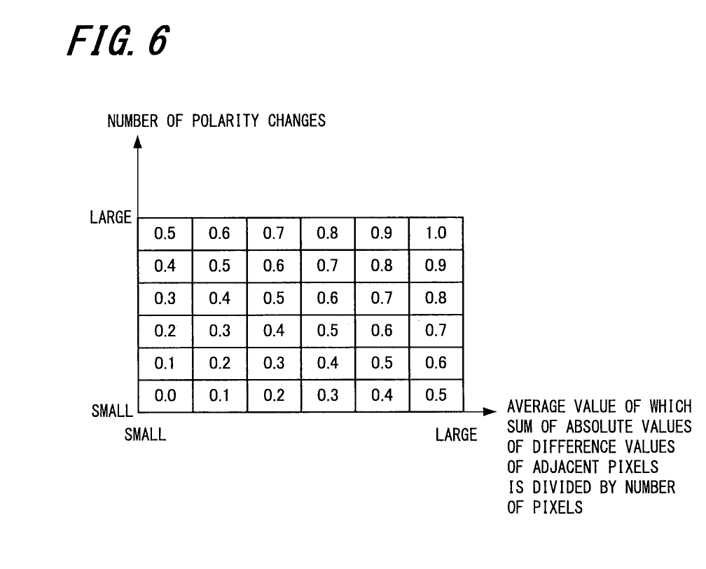

FIG. 6 shows an example of a structure of the vibration period deciding LUT 204. In the vibration period deciding LUT 204, the horizontal axis represents average values of sums of absolute values of difference values of adjacent pixels and the vertical axis represents numbers of polarity changes. Both on the horizontal axis and the vertical axis, numeric values increase as they are away from the origin. Numeric values that represent vibration periods are normalized as 0.0 (minimum value) to 1.0 (maximum value). Likewise, vibration periods are normalized on the LUT such that they increase as they are away from the origin.

In other words, the vibration period for which a voltage is applied to a vibration device Pe increases in proportion to the average value of which the sum of absolute values of adjacent pixels in a predetermined region is divided by the number of pixels and the number of polarity changes. The normalized vibration periods (hereinafter referred to as normalized vibration periods) in the vibration period deciding LUT 204 can be adjusted, for example, by multiplying them by any coefficient.

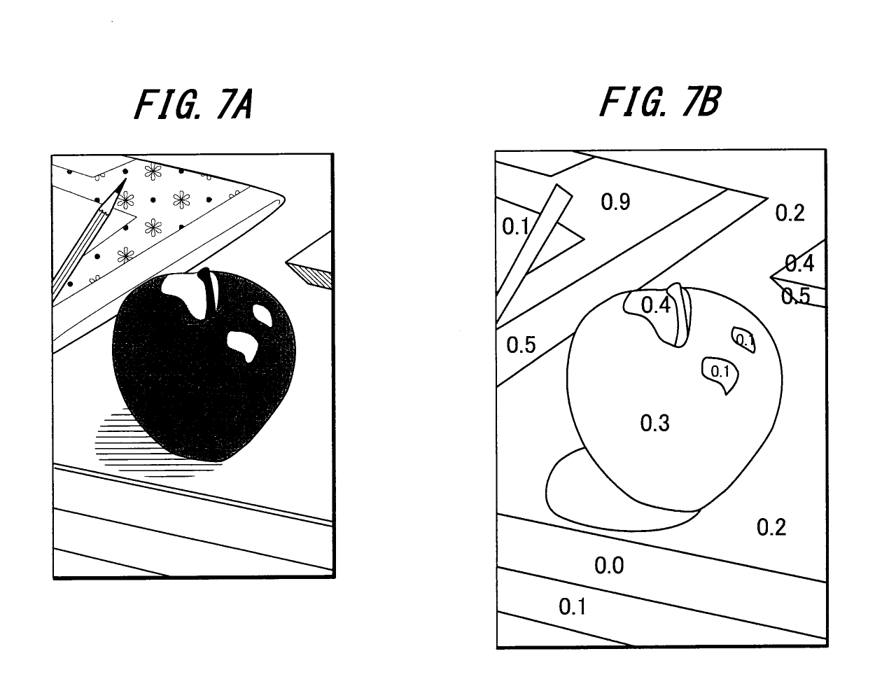

FIG. 7A and FIG. 7B show an example of the relationship of a real image and normalized vibration periods obtained by the process of the control section 210. FIG. 7A shows a real image. FIG. 7B shows a state that normalized vibration periods are assigned corresponding to a feature amount of the image. Since a handkerchief illustrated at an upper left portion of FIG. 7A has a pattern, the difference values of adjacent pixels become large and does the number of polarity changes of pixel values of adjacent pixels. Thus, as shown in FIG. 7B, it is clear that a large normalized vibration period of 0.9 is assigned to this area and that small normalized vibration periods such as 0.0 and 0.1 are assigned to featureless regions where luminance values do not change.

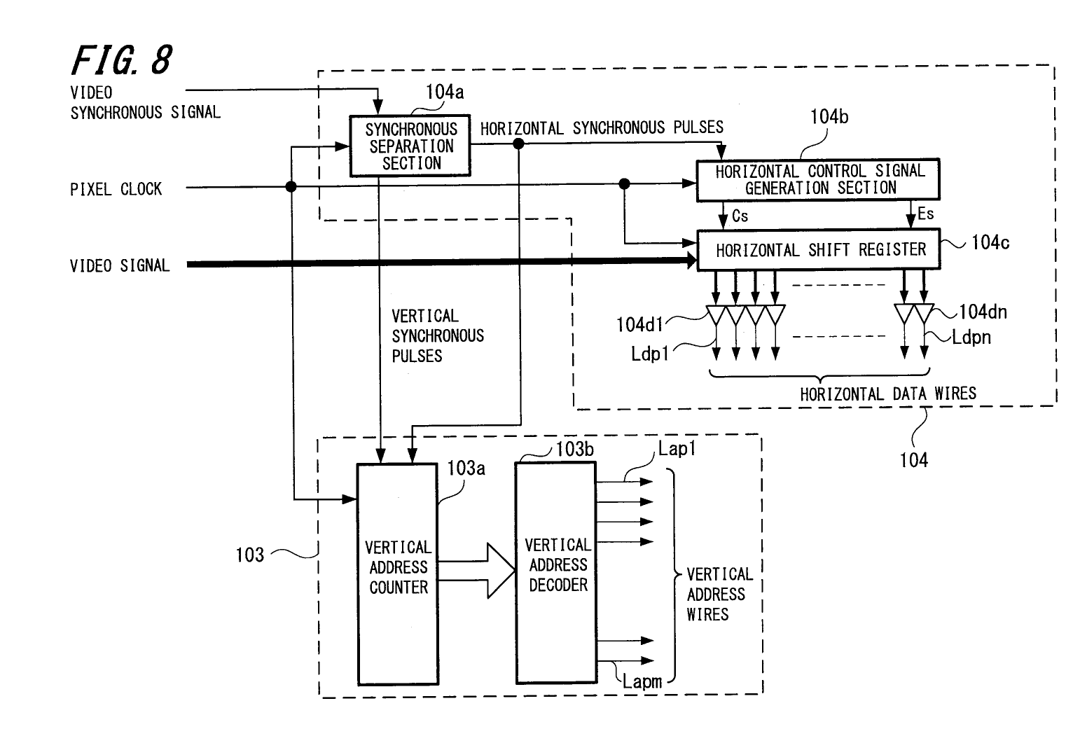

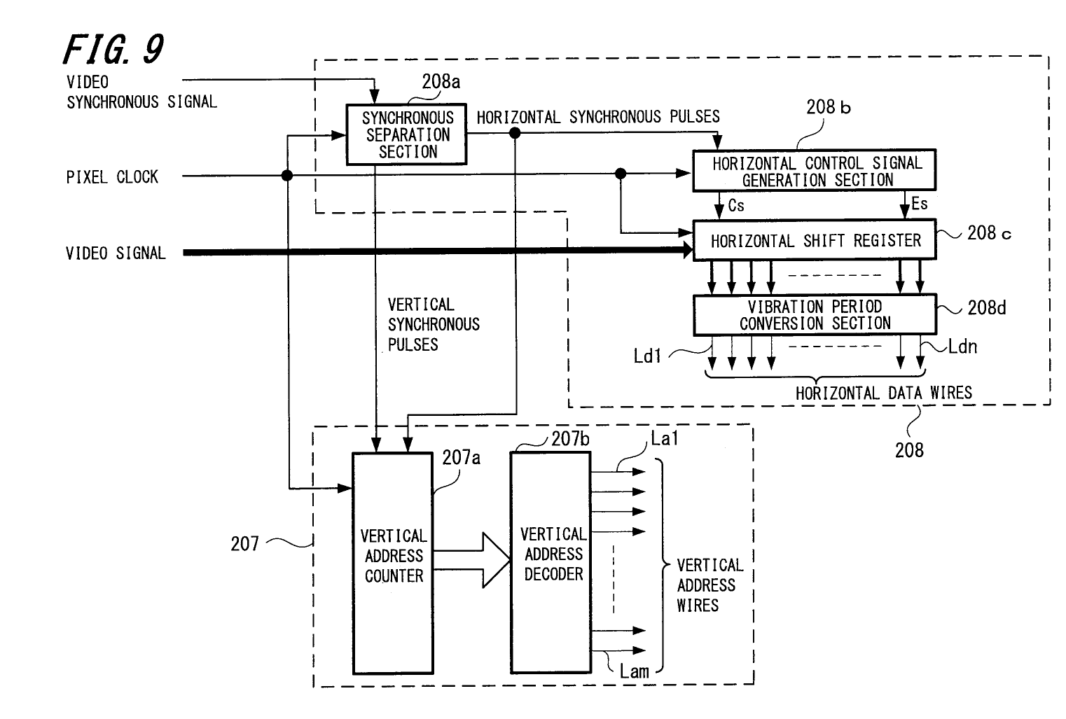

Next, with reference to FIG. 8 and FIG. 9, structures of driving sections of the image display panel 105 and the vibration device panel 209 will be described. FIG. 8 is a schematic diagram showing an example of internal structures of the vertical driving section 103 and the horizontal driving section 104 of the image display panel 105. FIG. 9 is a schematic diagram showing an example of internal structures of the vertical driving section 207 and the horizontal driving section 208 of the vibration device panel 209.

The vertical driving section 103 shown in FIG. 8 includes a vertical address counter 103a and a vertical address decoder 103b. The vertical address counter 103a counts vertical address wires Lap1 to Lapm in synchronization with vertical synchronous pulses and horizontal synchronous pulses supplied from a synchronous separation circuit 104a and outputs a vertical address obtained as the counted result to the vertical address decoder 103b. The vertical address decoder 103b supplies a low signal to a vertical address wire Lapi (where i is a natural number) corresponding to the vertical address that is output from the vertical address counter 103a.

The horizontal driving section 104 includes the synchronous separation section 104a that separates vertical synchronous pulses and horizontal synchronous pulses from the video synchronous signal, a horizontal control signal generation section 104b that generates various types of control signals based on horizontal synchronous pulses, and a horizontal shift register 104c. In addition, the horizontal driving section 104 includes digital-to-analog conversion sections 104d1 to 104dn that convert a video signal that is output from the horizontal shift register 104c into an analog video signal.

The horizontal control signal generation section 104b generates a clear signal Cs and an enable signal Es in synchronization with horizontal synchronous pulses and pixel clock pulses and outputs these signals to the horizontal shift register 104c. The horizontal shift register 104c successively stores a video signal for one horizontal line that is output from the video memory 101 (see FIG. 4). When the clear signal Cs is input to the horizontal shift register 104c, it successively outputs the video signal to the digital-to-analog conversion sections 104d1 to 104dn. The digital-to-analog conversion sections 104d1 to 104dn convert the video signal supplied from the horizontal shift register 104c into an analog video signal and output the analog video signal to the horizontal data wires Ldp1 to Ldpn, respectively.

The vertical driving section 207 of the vibration device panel 209 shown in FIG. 9 includes a vertical address counter 207a and a vertical address decoder 207b. The vertical address counter 207a counts vertical address wires La1 to Lam in synchronization with vertical synchronous pulses and horizontal synchronous pulses supplied from a synchronous separation section 208a that will be described later and outputs a vertical address as the counted result to the vertical address decoder 207b. The vertical address decoder 207b supplies a low signal to a vertical address wire Lai corresponding to the vertical address that is output from the vertical address counter 207a.

The horizontal driving section 208 includes a synchronous separation section 208a, a horizontal control signal generation section 208b, a horizontal shift register 208c, and a vibration period conversion section 208d.

The synchronous separation section 208a separates vertical synchronous pulses and horizontal synchronous pulses from the video synchronous signal. The horizontal control signal generation section 208b generates the clear signal Cs and the enable signal Es in synchronization with horizontal synchronous pulses and outputs these signals to the horizontal shift register 208c. The horizontal shift register 208c successively stores the vibration period signal for one horizontal line that is output from the vibration period signal memory 205 (see FIG. 4). When the clear signal Cs is input to the horizontal shift register 208c, it successively outputs the vibration period signal to the vibration period conversion section 208d. The vibration period conversion section 208d converts the vibration period signal that is output from the horizontal shift register 208c into a PWM signal and successively supplies the PWM signal to each of the horizontal data wires Ld1 to Ldn.

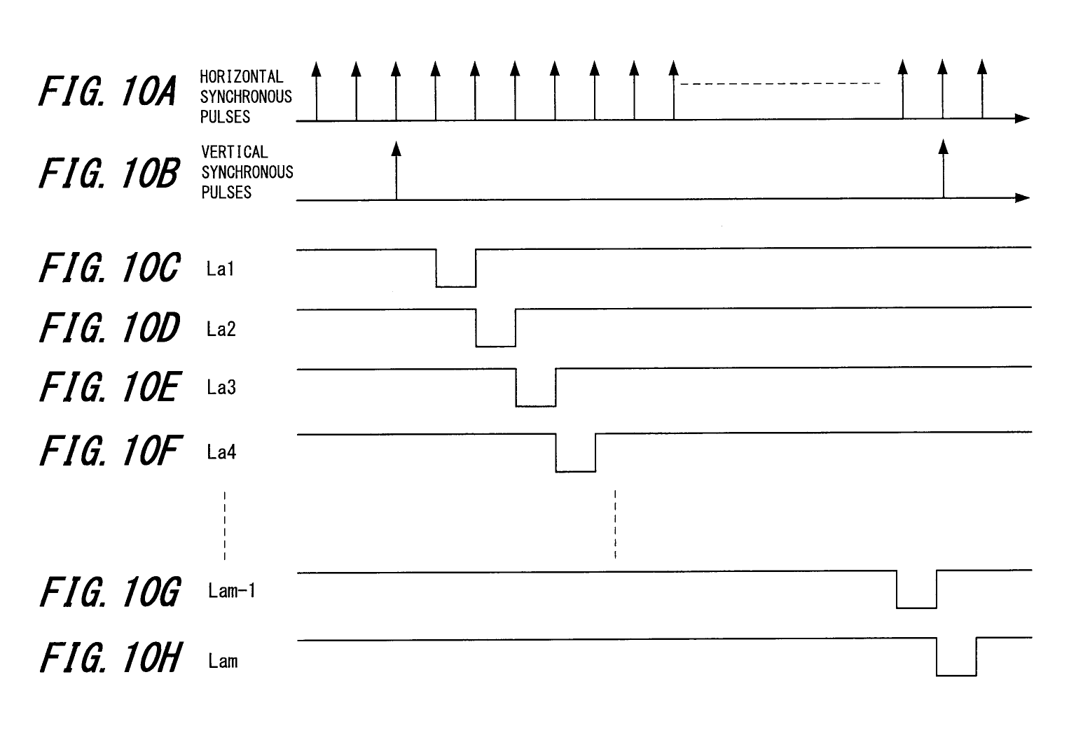

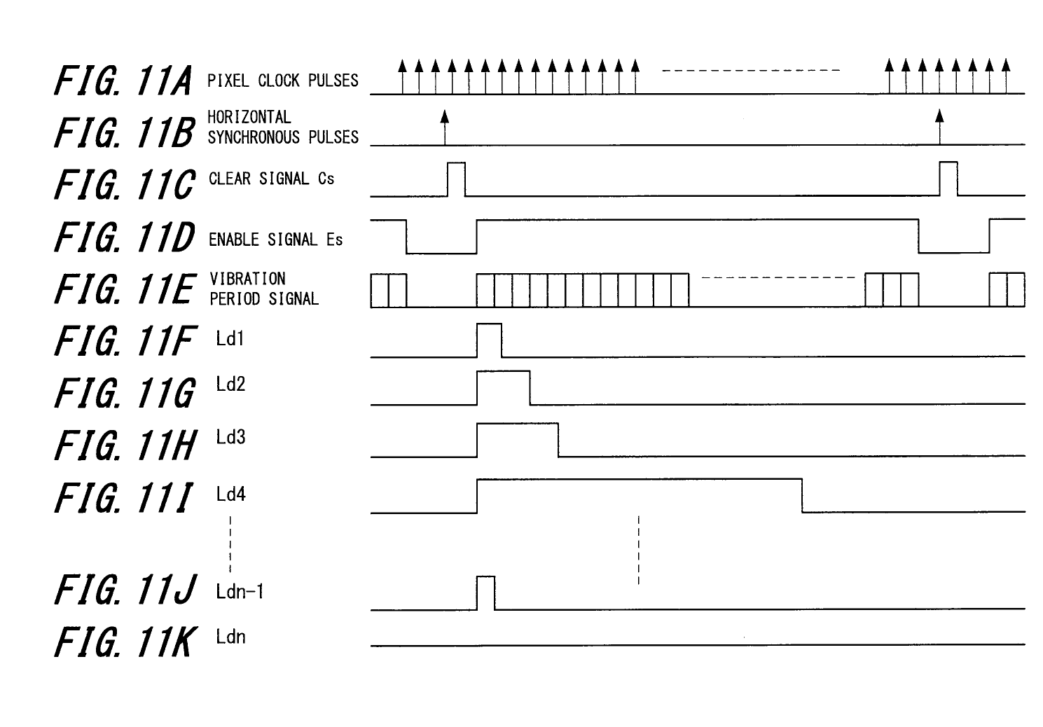

Next, with reference to timing charts shown in FIG. 10A to FIG. 10H and FIG. 11A to FIG. 11K, an example of a process performed in each section of the vertical driving section 207 and the horizontal driving section 208 that drive the vibration devices Pe will be described. FIG. 10A to FIG. 10H are timing charts showing an operation of the vertical driving section 207. FIG. 11A to FIG. 11K are timing charts showing an operation of the horizontal driving section 208.

FIG. 10A shows horizontal synchronous pulses. FIG. 10B shows vertical synchronous pulses. Horizontal synchronous pulses are pulses generated corresponding to individual horizontal lines of the video signal. Vertical synchronous pulses are pulses generated corresponding to individual frames of the video signal. FIG. 10C to FIG. 10H show vertical address wires La1 to Lam, respectively (vertical address wires La5 to Lam-2 are omitted).

FIG. 10A to FIG. 10H show that the low signal generated in synchronization with the vertical synchronous pulses is successively supplied to the vertical address wires La1 to Lam. The period for the low signal is the same as the period for one horizontal line. Horizontal lines are successively designated in synchronization with horizontal synchronous pulses (in the vertical direction of an image).

FIG. 11A to FIG. 11K show an example of an operation of the horizontal driving section 208. FIG. 11A shows pixel clock pulses. FIG. 11B shows horizontal synchronous pulses. FIG. 11C shows a clear signal. FIG. 11D shows an enable signal. FIG. 11E shows a vibration period signal. FIG. 11F to FIG. 11K show horizontal data wires Ld1 to Ldn, respectively (horizontal data wires Ld5 to Ldn-2 are omitted).

In FIG. 11A to FIG. 11K, the horizontal shift register 208c is operated based on the clear signal Cs and the enable signal Es generated in synchronization with horizontal synchronous pulses. The vibration period signal generated at intervals of individual pixels P is successively stored in the horizontal shift register 208c. The vibration period signal stored in the horizontal shift register 208c is output to the horizontal data wires Ld1 to Ldn at the same time when the clear signal Cs is output to the horizontal shift register 208c. A high signal is supplied to the horizontal data wires Ld1 to Ldn such that the durations of the high signal differ for the horizontal data wires Ld1 to Ldn.

While the high signal is being supplied to a vibration device pe through a corresponding horizontal data wire Ld, a corresponding vibration device Pe is vibrated. While the high signal is not being supplied to the vibration device Pe, it is not vibrated.

The durations of the high signal supplied to the horizontal data wires Ld1 to Ldn are different because periods designated by the vibration period signal differ for each of the horizontal data wires Ld1 to Ldn.

In other words, a voltage supply period for an i-th, j-th vibration device Pe disposed depends on the period for the low signal supplied to the vertical address wire Lai and the period for the high signal supplied to the horizontal data wire Ldj (where i and j are any natural numbers in the vertical and horizontal directions, respectively).

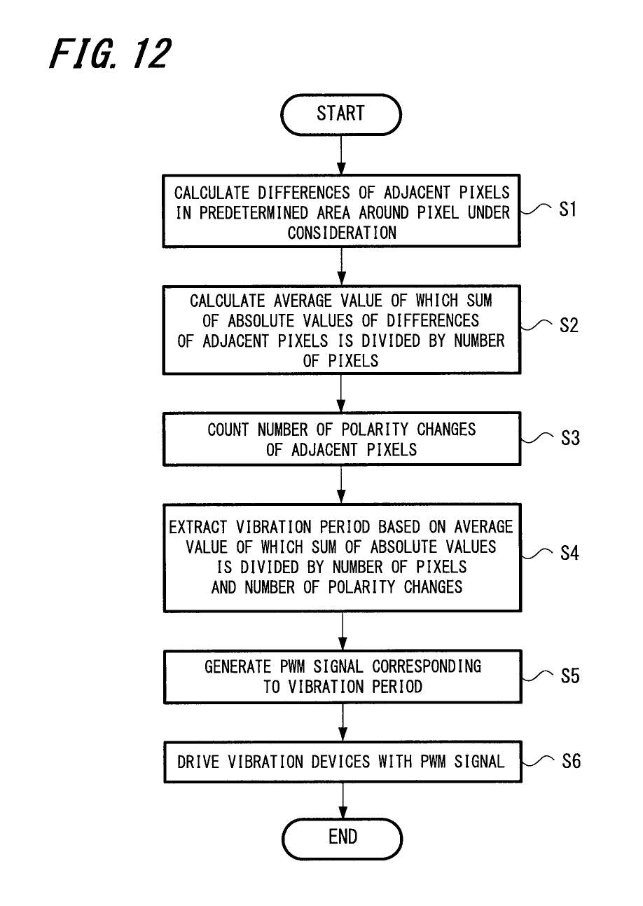

FIG. 12 is a flowchart showing an example of a process of the image display apparatus according to an embodiment of the present invention. First, the difference calculation section 201 of the control section 210 calculates the differences of adjacent pixels in a predetermined area around a pixel under consideration (at step S1). The average value calculation section 202 calculates the average value of which the sum of the absolute values of the differences of the adjacent pixels is divided by the number of pixels (at step S2). Thereafter, the counting section 203 calculates the number of the polarity changes of adjacent pixels in the predetermined area (at step S3). The vibration period deciding LUT 204 extracts a vibration period that depends on the average value of which the sum of the absolute values is divided by the number of pixels and the number of polarity changes (at step S4).

Thereafter, a PWM signal is generated based on the vibration period (at step S5). When the PWM signal is supplied to a particular vibration device Pe under the control of the vertical driving section 207 and the horizontal driving section 208, the vibration device Pe is driven and vibrated (at step S6).

According to the foregoing embodiment, since the vibration devices Pe are disposed corresponding to the pixels P in the relationship of one to one, not only an image is displayed on the display screen, but the vibration devices Pe are also vibrated. Thus, the user can visually and tactually recognize an object.

In this case, since the size of each of the vibration devices Pe is sufficiently smaller than that of each of the pixels P and the vibration devices Pe are disposed corresponding to the pixels P, a presentation screen that presents an object with vibrations can have the same resolution as that of a displayed image.

In this case, a period for which a voltage is applied to a vibration device Pe is set based on a change amount of pixel values of adjacent pixels P. Thus, vibrations of the vibration devices Pe correspond to content displayed as an image.

In addition, since the vibration devices Pe are individually addressed by the vertical address wires La and the horizontal data wires Ld, the individual vibration devices Pe can be vibrated corresponding to content of a display of the pixels P corresponding to the vibration devices Pe.

According to an embodiment of the present invention, the periods for which voltages are applied to the vibration devices Pe can be obtained by referring to the vibration period deciding LUT 204 that has been prepared. In the vibration period deciding LUT 204, the vibration periods are set such that as changes of pixel values of adjacent pixels become large or the number of polarity changes becomes large, the vibration period becomes longer. Thus, at an uneven region of an image, the vibration devices Pe are vibrated. At a flat region of the image, the vibration devices Pe are not vibrated.

In the vibration period deciding LUT 204, vibration periods have been set corresponding to change amounts of pixel values and the number of polarity changes when pixel values are changed. Thus, at a finely uneven region of an image, the vibration devices Pe are strongly vibrated. At a largely uneven region of an image, the vibration devices Pe are weakly vibrated. Thus, the texture of the object can be represented by vibrations.

The foregoing embodiment was applied for a system using the rear projection type projector 100. However, an embodiment of the present invention may be a system composed of a front projection type projector and a screen. Instead, an embodiment of the present invention may be panel illumination type displays such as a liquid crystal display (LCD) and a plasma display panel (PDP).

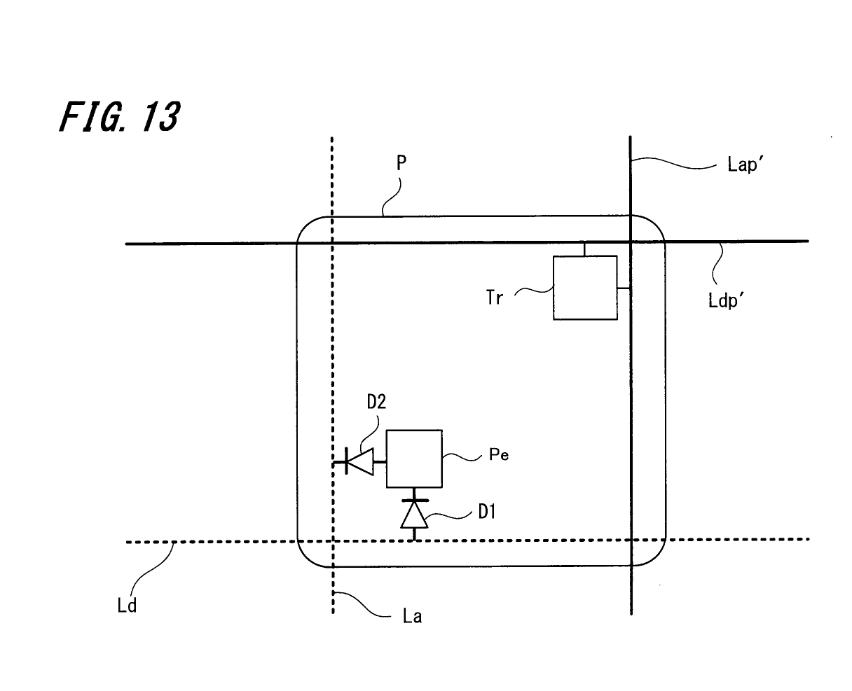

FIG. 13 is a schematic diagram showing an example of arrangement of pixels P and vibration devices Pe used for an LCD composed, for example, of a liquid crystal panel. FIG. 13 shows that a pixel driving section Tr composed of a transistor or the like is disposed at an intersection of a vertical address wire Lap′ and a horizontal data wire Ldp′ that drive a pixel P. FIG. 13 also shows that a vertical address wire La and a horizontal data wire Ld are connected through a diode D1 and a diode D2, respectively, to a vibration device Pe disposed corresponding to the pixel P.

Thus, when vibration devices Pe are disposed corresponding to pixels P in the relationship of one to one, an image and vibrations can be simultaneously presented with a display such as an LCD.

In the foregoing embodiment, pixels P and vibration devices Pe are disposed correspondingly in the relationship of one to one. Instead, pixels P and vibration devices Pe may be disposed correspondingly in the relationship of another ratio such as two to one or three to one. In other words, one vibration device Pe may be disposed every a predetermined number of pixels P such that the number of vibration devices Pe is decimated from the number of pixels P.

In addition, in the foregoing embodiment, the vibration periods for the vibration devices Pe are controlled with periods for which voltages are applied to the vibration devices Pe, respectively. Instead, the vibration periods for the vibration devices Pe may be controlled by adjusting the pulse width of the PWM signal.

In the foregoing embodiment, the vibration devices Pe are composed of piezoelectric devices. Instead, other devices may be used as long as they are pressure-to-electricity converting devices.

In the foregoing embodiments, the texture of an image displayed on a screen is reproduced by vibrations of the vibration devices Pe. Instead, for example, content represented by pseudo colors may be correlated with vibrations. When a temperature distribution in an area represented by a natural image is displayed by pseudo colors, the vibration devices Pe may be vibrated corresponding to a color that represents a portion having the highest temperature. In addition, when an image having a plane pattern and a gradation where pixel values are gradually changing is represented by pseudo colors, by vibrating vibration devices Pe disposed at boundaries of the gradation, the gradation can be represented by vibrations.

Instead, an embodiment of the present invention may be applied to a structure that by extracting edge portions of an image and vibrating only vibration devices Pe disposed at positions extracted as the edge portions, the user can easily recognize the shape of an object by his or her tactual sense.

Instead, when an object in an image is tracked by a technique such as pattern-matching or the object itself is extracted, an embodiment of the present invention may be applied to a structure that the motion of the object as a result of tracking and information about the position of the object are recognized by vibrations.

In addition, an embodiment of the present invention may be applied to a medical application that a moving image of a beating heart is reproduced by vibrations. In this case, a representative value or an average value of a moving vector may be calculated as a feature amount of the heart from the image. Instead, the area or the like of the heart may be calculated. The vibration devices Pe may be vibrated in proportion to the calculated values.

The present application contains subject matter related to that disclosed in Japanese Priority Patent Application JP 2008-106133 filed in the Japanese Patent Office on Apr. 15, 2008, the entire content of which is hereby incorporated by reference.

It should be understood by those skilled in the art that various modifications, combinations, sub-combinations and alternations may occur depending on design requirements and other factors insofar as they are within the scope of the appended claims or the equivalents thereof.

What is claimed is:

1. An image display apparatus, comprising:
a display section configured to display an image;
vibrators each structured to have a smaller size than that of each of pixels that compose the image and disposed on a display surface of the display section corresponding to the pixels; and
a driving section configured to vibrate the vibrators.

2. The image display apparatus as set forth in claim 1,
wherein the vibrators are pressure-to-electricity converting devices that vibrate with a voltage applied.

3. The image display apparatus as set forth in claim 2,
wherein the vibrators are controlled with respective electrodes disposed in a matrix shape corresponding to positions at which the vibrators are disposed.

4. The image display apparatus as set forth in claim 3,
wherein the driving section vibrates the vibrators corresponding to a feature amount detected from an image displayed on the display section.

5. The image display apparatus as set forth in claim 4,
wherein the feature amount of the image is a change amount of a pixel value in predetermined area around a pixel under consideration.

6. The image display apparatus as set forth in claim 5, further comprising:
a control section configured to extract the feature amount of the image,
wherein the control section includes:
a difference calculation section that calculates difference values of adjacent pixels in the predetermined range around the pixel under consideration,
an average value calculation section that calculates an average value, of which a sun of absolute values of difference values of adjacent pixels is divided by a number of pixels, calculated by the difference calculation section;
a polarity change counting section that obtains a number of changes of polarities of adjacent pixels in the predetermined range; and
a table that correlates the average value of which the sun of absolute values of difference values of adjacent pixels is divided by the number of pixels, the number of changes of the polarities, and vibration periods of the vibrators.

7. The image display apparatus as set forth in claim 6,
wherein the table is pre-set such that vibration periods of the vibrators become longer as the average value of which the sun of the absolute values of the difference values of the adjacent pixels is divided by the number of pixels and/or the number of the polarity becomes large.

8. The image display apparatus as set forth in claim 4,
wherein information extracted as the feature amount of the image is colors of the image.

9. The image display apparatus as set forth in claim 4,
wherein information extracted as the feature amount of the image is an edge portion of the image.

10. The image display apparatus as set forth in claim 4,
wherein information extracted as the feature amount of the image is a moving vector of a moving image.

11. The image display apparatus as set forth in claim 4,
wherein information extracted as the feature amount of the image is a result of a pattern matching process performed for the image.

12. An image display method, comprising the steps of:
displaying an image; and
driving vibrators structured to have a smaller size than that of each of pixels that compose the image and disposed on a display surface of a display section corresponding to the pixels.
